(19) United States
(12) Patent Application Publication
(10) Pub. No.: US 2006/0095851 A1
(43) Pub. Date: May 4, 2006

(54) Methods and systems for facilitating acting in conjunction with performance of a movie

(76) Inventor: Anastasia Fite, Brooklyn, NY (US)

Correspondence Address: KIRKPATRICK & LOCKHART NICHOLSON GRAHAM LLP, 535 SMITHFIELD STREET, PITTSBURGH, PA, 15222, US

(21) Appl. No.: 11/251,151

(22) Filed: Oct. 14, 2005

Related U.S. Application Data
(60) Provisional application No. 60/618,822, filed on Oct. 14, 2004.

(51) Int. Cl. G11B 27/00; G06F 3/00; G06F 17/00; H04N 7/16; G06F 9/00

(52) U.S. Cl. 715/723; 715/733; 715/730; 725/135

(57) ABSTRACT

A computer-assisted method is disclosed for assisting a performer to act in association with at least a portion of a movie. In various embodiments, the method includes providing a screen configured to display the movie portion thereon; providing a library of movies for facilitating selection of the movie portion to be displayed on the screen; permitting scanning of a movie selected from the library on a media player computer system to identify the movie portion to be enacted by the performer; operatively associating the media player with a movie projector and at least one alternate monitor; and, configuring and positioning the alternate monitor to permit viewing by the performer of subtitles associated with the movie portion to facilitate acting by the performer in conjunction with the movie portion.

### CROSS-REFERENCE TO RELATED APPLICATION/PRIORITY CLAIM

The present application claims priority to U.S. Provisional Patent Application Ser. No. 60/618,822, entitled “Methods and Systems for Facilitating Acting in conjunction with Performance of a Movie,” filed on Oct. 14, 2004, the entirety of which is hereby incorporated by reference.

### FIELD OF THE INVENTION

The present invention generally relates to methods, processes, systems, computer program products, and computer-readable media that permit actors and actresses to conduct an acting performance in association with parallel performance of a movie or a similar cinematic presentation.

### BACKGROUND

Karaoke is a well-known form of entertainment that permits a participant or performer to sing along with a song as it is played. Conventional karaoke systems typically provide a performer with a visual presentation of song lyrics or other musical content, such as by use of subtitles presented on a video monitor, for example. These systems usually play songs and other music in parallel with presenting the song lyrics visually to performers, thereby enabling the performers to sing songs without memorizing the lyrics. To enhance the entertainment experience, karaoke performances may be viewed by an audience of potential performers and/or other interested observers.

What traditional karaoke systems lack, however, is the ability for a performer or multiple performers to act along with, in addition to, or in place of a scene or scenes from a movie. What are needed, therefore, are improved methods and systems that permit acting performances to be conducted in conjunction with playing and viewing movies.

### BRIEF DESCRIPTION OF THE FIGURES

The accompanying drawings, which are incorporated into and constitute a part of this specification, illustrate embodiments of the invention. Together with the description of the embodiments provided herein, the drawings serve to explain the principles of the present invention for those skilled in the art.

FIG. 1 includes a schematic representation of a performer acting in association with display of a movie portion, FIG. 1 includes illustrations of examples of various system and process aspects that can be provided in accordance with embodiments of the present invention; and,

FIG. 2 includes a process flow diagram illustrating a sample method that may be conducted in accordance with embodiments of the invention.

### DESCRIPTION

As applied herein, the term “movie” may include any motion picture, film, video, or other cinematic presentation having at least a script that can be followed, enhanced, and/or supplanted by the performance of one or more actors. In certain embodiments of the present invention, the particular movie employed, or the portion thereof performed by the actor or actors, may exclude components such as music, songs or other musical elements of similar character.

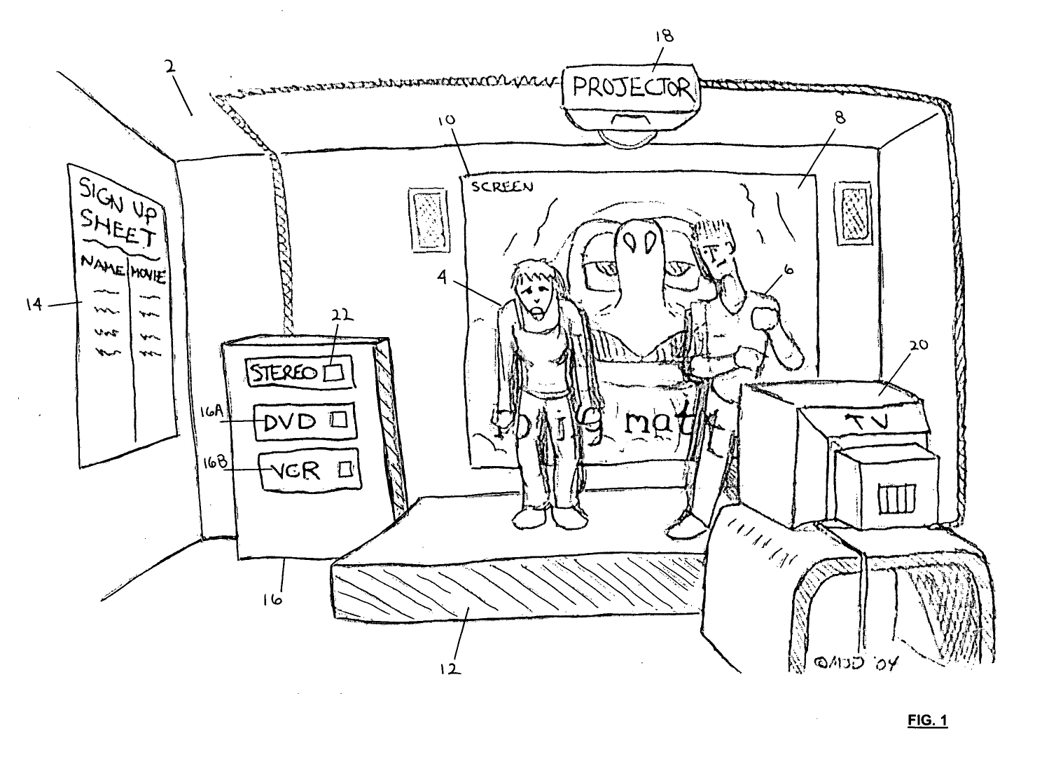

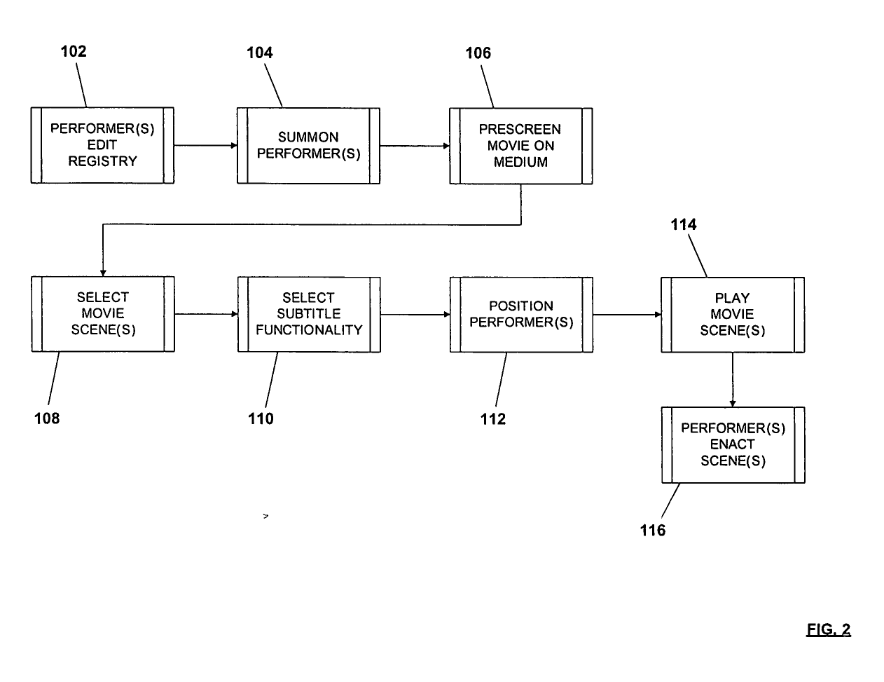

Referring now to FIGS. 1 and 2, various method and system embodiments of the present invention are illustrated. As shown in FIG. 1, in a screening room 2 one or more patrons may view one or more performers 4, 6 acting in association with a movie 8 being played on a screen 10. The screening room 2 may be a lounge or bar area, for example, or any other area suitable for viewing movies. The performers 4, 6 may conduct their performance with or without the use of a stage 12, for example, or another functionally similar structure.

In step 102, upon entering the screening room 2, each patron may edit a registry 14 or list, for example, with the name of the patron, a title of a movie, and/or a particular scene or scenes from the designated movie that the patron wishes to enact on the stage 12. Patrons may bring their own favorite movies to the screening room 2 on a suitable computer-readable medium (e.g., DVD), or a library of movies on various media may be made available to patrons by the proprietor, for example, of the screening room 2. The registry 14 may be a paper or chalkboard medium or may be an electronic device configured to receive input from patrons.

In step 104, based on a review of the registry 14, one or patrons (e.g., the performers 4, 6) are summoned from the viewing audience to act in association with a scene or scenes from a movie. At this point, in step 106, the medium on which the desired movie 8 is stored may be prescreened or scanned to identify the particular scene or scenes that are to be played in association with activity of the performers 4, 6. Depending on the type of medium employed, the movie 8 or portions thereof may be prescreened or played in step 106 on a variety of media players 16 such as a DVD player 16A or a VCR 16B, for example. For purposes of illustration, assuming the medium of choice is a DVD, for example, the chapter menu of the movie 8 content on the DVD can be scanned in step 106 to identify the scene or scenes desired by the performers 4, 6. When the scene or scenes of the movie 8 on the DVD have been selected in step 108, an appropriate language for subtitles (e.g., English, Spanish, etc.) may be selected in step 110 from menu choices available on the DVD or by use of functionality associated with the DVD player 16A.

As shown in FIG. 1, the media players 16 are operatively connected to at least one of a movie projector 18 and an alternate monitor 20 (e.g., a television monitor). Operative connection of the media players 16, the movie projector 18, and the alternate monitor 20 may be enabled by suitable cable connectors and/or splitters that communicate signals between/among these devices 16, 18, 20. In step 112, the performers 4, 6 are generally positioned in front of the screen 10 between the movie projector 18 and the screen 10. As shown, the movie projector 18 may be configured and positioned to display the movie 8 on the screen 10 with the projection superimposed on the performers 4, 6. In certain embodiments, signals carrying the content of the movie 8 may be fed directly from the media players 16 to the screen 10, rather than to the projector 18, to avoid superimposing a projection onto the performers 4, 6. The alternate monitor 20 may be configured and positioned so that the movie 8, and any subtitles provided in association with the movie 8, may be viewed by the performers 4, 6 to facilitate their acting in conjunction with a scene or scenes of the movie 8. In certain embodiments of the invention, multiple movie projectors 18 and/or alternate monitors 20 may be employed during a performance.

In step 114, the media player 16 is activated to play the selected scene or scenes from the desired movie 8. The performers 4, 6 may then begin to enact the scene or scenes in step 116 optionally using the subtitles displayed on the screen 10 and/or from the images displayed on the alternate monitor 20 as a guide to their performance. In certain embodiments, audio or other sounds associated with the movie 8 may be turned on, turned off, reduced in volume or enhanced in volume at the option of the performers 4, 6. For example, a dance scene in the movie 8 could have full volume, while an action/dialogue scene could alternate between using a portion of the audio track of the movie 8 and muting the audio. In alternative embodiments, computer-readable media that include an audio track without actors' voices, for example, may be employed in lieu of a standard DVD movie, for example.

The performers 4, 6 may enact any manner of human dialogue or script from the movie 8, or may perform non-human parts of the movie 8 (e.g., a dog, a helicopter, or any other aspect of the movie 8). In certain embodiments, props may be provided for use by the performers 4, 6 while enacting a scene or scenes, and/or the performers 4, 6 may dress themselves to reflect the dress or manner of certain character or characters in the movie 8. For example, the performers 4, 6 may elect to deviate from the actual action or script within the scene of the movie 8 and interpret a character in any manner. The performers 4, 6 may also provide new lines for their characters, in essence rewriting the script of the movie 8 and enhancing the opportunities for creative employment of the invention.

In addition, one or more microphones may be provided and configured in the vicinity of the stage 12, for example, to enhance the performance. Also, a stereo 22 or other musical media player may be employed in the screening room 2 to add further audio elements to performances and/or to provide entertainment for the viewing audience during breaks between performances, for example.

It can be appreciated that the present invention offers an interactive environment in which a performer can enact scenes from films from any era or genre to give voice to characters in the movies with the aid of the movies and/or their subtitles. It represents a departure from conventional forms of entertainment in that it allows performers to re-enact, mimic, and/or re-interpret the roles of actors or other aspects of movies. The present invention also offers an interactive experience for the viewing audience in a way that simulates the excitement of participating in live theater.

Aspects of the present invention may also be tailored to different audiences such as the elderly or children, for example, or can be used as a device for bringing singles together who share a love of film. In addition, performers may act along with a documentary, for example, by keeping the audio of the narrative of the documentary playing while acting out the historical moment being described. It can be appreciated that embodiments of the present invention may also be useful to professional actors and/or actors-in-training as a valuable tool for improvement or teaching of acting skills.

The examples presented herein are intended to illustrate potential and specific implementations of the present invention. It can be appreciated that the examples are intended primarily for purposes of illustration of the invention for those skilled in the art. No particular aspect or aspects of the examples is/are intended to limit the scope of the present invention.

It is to be understood that the figures and descriptions of the present invention have been simplified to illustrate elements that are relevant for a clear understanding of the present invention, while eliminating, for purposes of clarity, other conventional elements. For example, certain media player operating details are not described herein. Those of ordinary skill in the art will recognize that these and other elements may be desirable in a typical entertainment system. Because such elements are well known in the art, however, and because they do not facilitate a better understanding of the present invention, a discussion of such elements is not provided herein.

Any element expressed herein as a means for performing a specified function is to encompass any way of performing that function including, for example, a combination of elements that perform that function. Furthermore the invention, as defined by such means-plus-function claims, resides in the fact that the functionalities provided by the various recited means are combined and brought together in a manner as defined by the appended claims. Therefore, any means that can provide such functionalities may be considered equivalents to the means shown herein.

In general, it will be apparent to one of ordinary skill in the art that some of the embodiments as described hereinabove may be implemented in many different embodiments of software, firmware, and hardware in the entities illustrated in the figures. The actual software code or specialized control hardware used to implement some of the present embodiments is not limiting of the present invention. For example, the embodiments described hereinabove may be implemented in computer software using any suitable computer software language type such as, for example, C or C++ using, for example, conventional or object-oriented techniques. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the present embodiments may be executed by programmable equipment, such as computers. Software that may cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable medium. Such a medium may include any of the forms listed above with respect to storage devices and may further include, for example, a carrier wave modulated, or otherwise manipulated, to convey instructions that may be read, demodulated/decoded and executed by a computer.

It can also be appreciated that certain process aspects described herein may be performed using instructions stored on a computer-readable medium or media that direct a computer system to perform the process aspects. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary. A computer-readable medium may further include one or more data signals transmitted on one or more carrier waves.

A “computer” or “computer system” may be, for example, a wireless or wireline variety of a microcomputer, minicomputer, server, mainframe, laptop, personal data assistant (PDA), wireless e-mail device (e.g., “BlackBerry” trade-designated devices), cellular phone, pager, processor, fax machine, scanner, or any other programmable device configured to transmit and receive data over a network. Computer systems disclosed herein may include memory for storing certain software applications used in obtaining, processing and communicating data. It can be appreciated that such memory may be internal or external to the disclosed embodiments. The memory may also include any means for storing software, including a hard disk, an optical disk, floppy disk, ROM (read only memory), RAM (random access memory), PROM (programmable ROM), EEPROM (electrically erasable PROM), and other computer-readable media.

In various embodiments of the present invention disclosed herein, a single component may be replaced by multiple components, and multiple components may be replaced by a single component, to perform a given function or functions. Except where such substitution would not be operative to practice embodiments of the present invention, such substitution is within the scope of the present invention.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention in the attached claims.

What is claimed is:

1. A computer-assisted method for assisting a performer to act in association with at least a portion of a movie, the method comprising:
providing a screen configured to display the movie portion thereon;
providing a library of movies for facilitating selection of the movie portion to be displayed on the screen;
permitting scanning of a movie selected from the library on a media player computer system to identify the movie portion to be enacted by the performer;
operatively associating the media player with a movie projector and at least one alternate monitor; and,
configuring and positioning the alternate monitor to permit viewing by the performer of subtitles associated with the movie portion to facilitate acting by the performer in conjunction with the movie portion.

2. The method of claim 1, wherein the movie portion excludes musical elements.

3. The method of claim 1, further comprising providing the screen in a screening room.

4. The method of claim 1, further comprising providing a stage on which the performer acts in association with the movie portion.

5. The method of claim 1, further comprising providing an editable registry to permit input therein by the performer of at least one of a name of the performer, a movie title, or a movie scene.

6. The method of claim 5, wherein the registry includes an electronic device configured to receive input from the performer.

7. The method of claim 1, wherein the media player includes a DVD player.

8. The method of claim 1, wherein the media player includes a VCR.

9. The method of claim 1, further comprising permitting selection of a language for a subtitle for the movie portion.

10. The method of claim 1, further comprising positioning the performer between the screen and the movie projector.

11. The method of claim 1, further comprising configuring the movie projector to display the movie portion on the screen with a projection superimposed on the performer.

12. The method of claim 1, further comprising feeding a signal carrying the movie portion directly from the media player to the screen to avoid superimposing a projection onto the performer.

13. The method of claim 1, further comprising turning off sound associated with the movie portion.

14. The method of claim 1, further comprising employing an audio track on the media player without any voices associated with the movie portion.

15. A system configured for assisting a performer to act in association with at least a portion of a movie, the system comprising:
a screen configured to display the movie portion thereon;
a media player computer system configured to identify the movie portion to be enacted by the performer;
a movie projector operatively associated with the media player; and,
at least one alternate monitor operatively associated with the media player, the alternate monitor being configured to permit viewing by the performer of subtitles associated with the movie portion to facilitate acting by the performer in conjunction with the movie portion.

16. The system of claim 15, wherein the movie portion excludes musical elements.

17. The system of claim 15, further comprising an editable electronic registry configured to permit input therein by the performer of at least one of a name of the performer, a movie title, or a movie scene.

18. The system of claim 15, wherein the media player includes at least one of a DVD player or a VCR.

19. The system of claim 15, further comprising the movie projector being configured to display the movie portion on the screen with a projection superimposed on the performer.

20. The system of claim 15, further comprising the media player being configured to feed a signal carrying the movie portion directly from the media player to the screen to avoid superimposing a projection onto the performer.
